(19) United States
(12) Patent Application Publication
(10) Pub. No.: US 2001/0016507 A1
(43) Pub. Date: Aug. 23, 2001

(54) Portable telephone with originator acknowledge function

(75) Inventor: Kiyoko Karusawa, Tokyo (JP)

Correspondence Address: Paul J. Esatto, Jr., Scully, Scott, Murphy & Presser, 400 Garden City Plaza, Garden City, NY, 11530, US

(73) Assignee: NEC Corporation, Tokyo (JP)

(21) Appl. No.: 09/782,905

(22) Filed: Feb. 14, 2001

(30) Foreign Application Priority Data
Feb. 18, 2000 (JP) 041796/2000

(51) Int. Cl. H04B 1/38

(52) U.S. Cl. 455/575; 455/567; 455/566; 455/517

(57) ABSTRACT

A portable telephone with an originator acknowledge function includes an originator confirmation button, response button, response mode controller, display, channel controller, message sending unit, and monitor. The response mode controller controls the response mode to an originator confirmation mode in which only reception is possible when the originator confirmation button is operated, and controls the response mode to a normal response mode in which both transmission and reception are possible when the response button is operated. The channel controller activates the response mode controller and connects a channel in the originator confirmation mode. The message sending unit sends a first message prompting a response of an originator to the channel when the channel is connected in the originator confirmation mode. The monitor outputs a speech signal of the originator from the channel to a recipient via a receiver after the first message is sent. The response mode controller switches the response mode from the originator confirmation mode to the normal response mode when the response button is operated during the originator confirmation mode.

### BACKGROUND OF THE INVENTION

The present invention relates to a portable telephone with an originator acknowledge function and, more particularly, to a portable telephone with an originator acknowledge function capable of rejecting a response to a malicious call or the like by confirming an originator.

In recent years, a service for setting whether a recipient (callee) is notified of a calling number has been offered in accordance with an originator's (caller's) request. When the calling number is set to be notified, it is directly displayed on the display screen of a portable telephone with a calling number display function on the recipient. Alternatively, the contents of a memory which stores correspondences between names and calling numbers are collated with the calling number of an incoming call, and when a calling number is registered, the name of the originator is displayed. The recipient confirms the calling number or the name of the originator on the display window, and rejects a response to a malicious call or the like.

Japanese Patent Laid-Open No. 10-42036 (reference 1) discloses an example of a terminating operation control method of rejecting a malicious call.

FIG. 6 shows the processing flow of the terminating operation control method described in reference 1. In this prior art, the contents of an operation designation registration memory is referred to for a calling number received in terminating operation, and a telephone is controlled to perform terminating operation designated for the calling number. Any one of operation 1 of not outputting any ringing tone, operation 2 of responding automatically, and operation 3 of rejecting terminating operation by automatic disconnection is registered in the operation designation registration memory in accordance with the calling number.

Terminating operation will be explained with reference to FIG. 6. If an incoming call is detected (step S1), a calling number is received as originating information (step S2), and whether the calling number is registered in a memory as a terminating rejection target whose termination is to be rejected is checked (step S3).

If Yes in step S3, it is determined which of operation 1 of not outputting any ringing tone (step S8), operation 2 of responding automatically (step S10), and operation 3 of rejecting terminating operation by automatic answering and forced disconnection is set as the type of terminating operation set for the calling number. The operation of not outputting any ringing tone (step S9), responding automatically (step S11), or performing on-hook operation immediately after off-hook operation (step S13) is executed as terminating operation in accordance with the determination result.

If NO in step S3, normal terminating operation is done. If the recipient inputs a specific code for the terminating rejection after the end of speech communication (step S5), an unregistered calling number is automatically transferred to the operation designation registration memory (step S6), and the type of terminating operation is newly automatically set for this calling number (step S7).

According to the conventional terminating operation control method shown in FIG. 6, a predetermined terminating operation is executed in accordance with a calling number notified in terminating operation. This enables avoiding only a malicious call.

In this portable telephone, however, when the originator makes a call without notifying the recipient of the calling number, the recipient cannot know the telephone number or name of the originator. In this case, the recipient responds to an incoming call once even for, e.g., a malicious call to which response rejection is set. In general, an originator aiming for annoyance or nuisance makes a call without notifying the recipient of the calling number so as to obstruct any trace. Thus, the recipient must respond to such an incoming call.

When a call is originated from a payphone, the recipient can know that the call is made from the payphone, but cannot know the name of originator. In many cases, the recipient does not know a calling number in advance even if the calling number is automatically notified, so the recipient cannot specify the originator. For this reason, even if the calling number is displayed on the recipient, it is difficult to discriminate the incoming call from a malicious call or the like.

As described above, in the conventional terminating operation control method for measure against a malicious call or the like, a calling number as a terminating rejection target is registered in a memory in advance, and terminating rejection operation is performed for only an incoming call from the registered calling number. It is, therefore, impossible to identify an incoming call such as a malicious call made from a payphone or a telephone in which calling number display is not set, and to reject a response to the incoming call.

### SUMMARY OF THE INVENTION

It is an object of the present invention to provide a portable telephone with an originator acknowledge function capable of responding after confirming an originator.

It is another object of the present invention to provide a portable telephone with an originator acknowledge function capable of avoiding a response to a malicious call made from a telephone in which calling number display is not set.

To achieve the above objects, according to the present invention, there is provided a portable telephone with an originator acknowledge function, comprising an originator confirmation button and response button, response mode control means for controlling a response mode to an originator confirmation mode in which only reception is possible when the originator confirmation button is operated, and controlling the response mode to a normal response mode in which both transmission and reception are possible when the response button is operated, display means for displaying a calling number received in terminating operation, channel control means for activating the response mode control means and connecting a channel in the originator confirmation mode in accordance with an operation of the originator confirmation button in terminating operation, message sending means for sending a first message prompting a response of an originator to the channel when the channel is connected in the originator confirmation mode, and monitor means for outputting a speech signal of the originator from the channel to a recipient via a receiver after the first message is sent, wherein the response mode control means switches the response mode from the originator confirmation mode to the normal response mode when the response button is operated during the originator confirmation mode.

### BRIEF DESCRIPTION OF THE DRAWINGS

FIG. 1 is a block diagram showing the arrangement of a portable telephone according to the first embodiment of the present invention;

FIG. 2 is a functional block diagram showing a portable telephone shown in FIG. 1;

FIG. 3 is a flow chart showing terminating operation of the portable telephone shown in FIG. 1;

FIG. 4 is a functional block diagram showing a portable telephone according to the second embodiment of the present invention;

FIG. 5 is a functional block diagram showing a portable telephone according to the third embodiment of the present invention; and

FIG. 6 is a flow chart showing terminating operation of a conventional portable telephone.

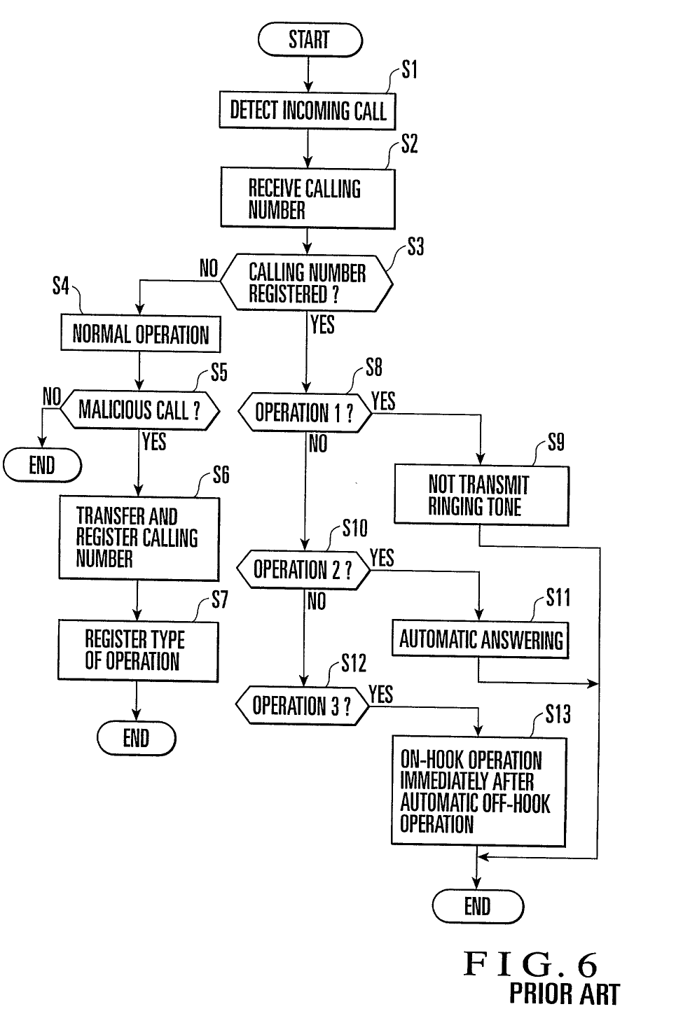

### DESCRIPTION OF THE PREFERRED EMBODIMENTS

The present invention will be described in detail below with reference to the accompanying drawings.

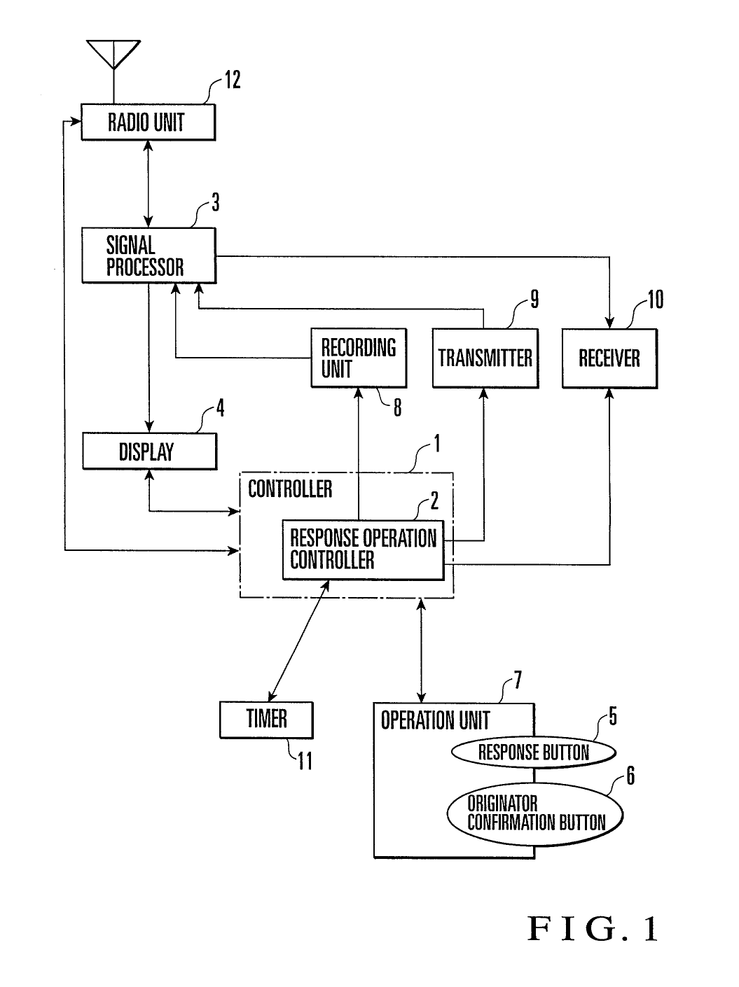

FIG. 1 shows a portable telephone with an originator acknowledge function according to the first embodiment of the present invention. In FIG. 1, the portable telephone of the first embodiment is constituted by a controller 1 having a response operation controller 2 for controlling two response operations: normal response (normal response mode) and originator acknowledge (originator confirmation mode) in terminating operation, a signal processor 3 for processing a received signal and transmission signal, a display 4 for displaying a calling number or the like received from the originator, an operation unit 7 having at least a response button 5 for inputting a normal response instruction and an originator confirmation button 6 for inputting an originator acknowledge instruction, a recording unit 8 for recording various answering messages, a transmitter 9 for inputting speech from the recipient, a receiver 10 for outputting speech received from the originator or an answering message to the originator, a timer 11 for counting the speech duration in the originator confirmation mode, and a radio unit 12 for communicating by radio with a base station (not shown). The controller 1 controls the display 4, recording unit 8, transmitter 9, receiver 10, operation unit 7, timer 11, and radio unit 12.

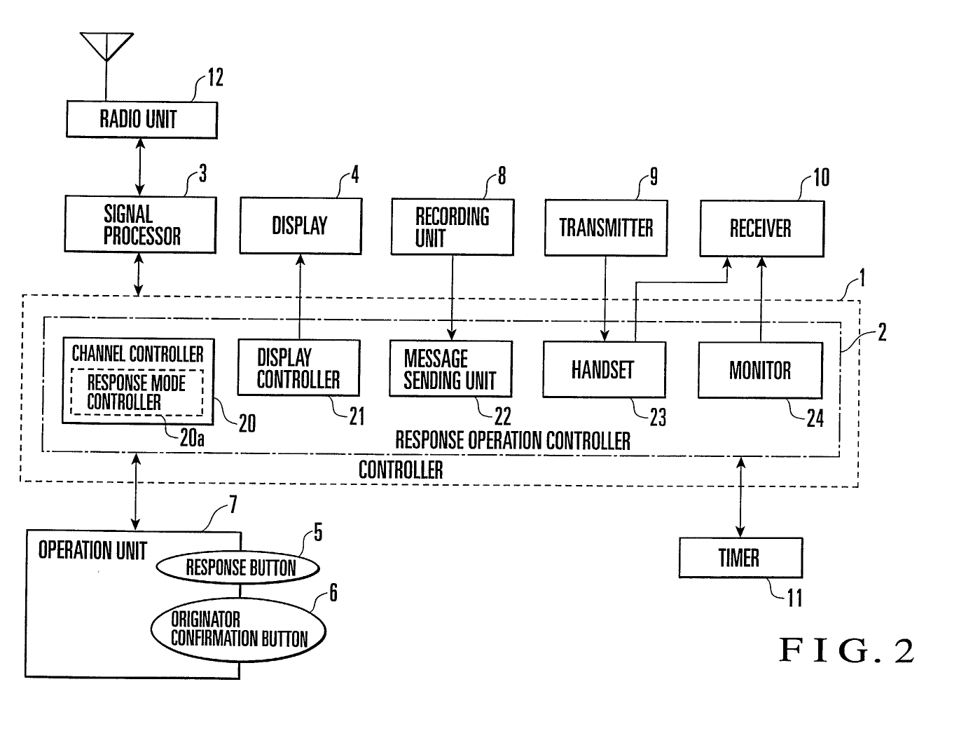

FIG. 2 shows the functions of the controller 1 as the arrangement of functional elements. In FIG. 2, the response operation controller 2 comprises a channel controller 20 having a mode controller 20a, a display controller 21, a message sending unit 22, a handset 23, and a monitor 24. The channel controller 20 controls the channel by the operation of the buttons 5 and 6 in terminating operation in addition to channel connection/disconnection control in the normal speech. As for speech from the originator, channel disconnection control is performed after a predetermined time elapses in a monitor state.

The mode controller 20a controls the response mode to the originator confirmation mode in which only reception is possible when the originator confirmation button 6 is operated, and controls the response mode to the normal response mode in which both transmission and reception are possible when the response button 5 is operated. Only the receiver 10 is enabled in the originator confirmation mode, whereas both the transmitter 9 and receiver 10 are enabled in the normal response mode.

The display controller 21 displays a calling number received in terminating operation, and when no calling number is received, controls the display 4 to display that no calling number was notified. The message sending unit 22 sends to the channel a message prompting a response to the originator and a response rejection message that are output from the recording unit 8. The handset 23 transmits and receives speech via the transmitter 9 and receiver 10 in the speech communication mode. The monitor 24 outputs speech from the originator to the recipient via the receiver 10 during the originator confirmation mode. The monitor 24 also outputs to the recipient via the receiver 10 a message requesting a name or the like to be sent to the originator.

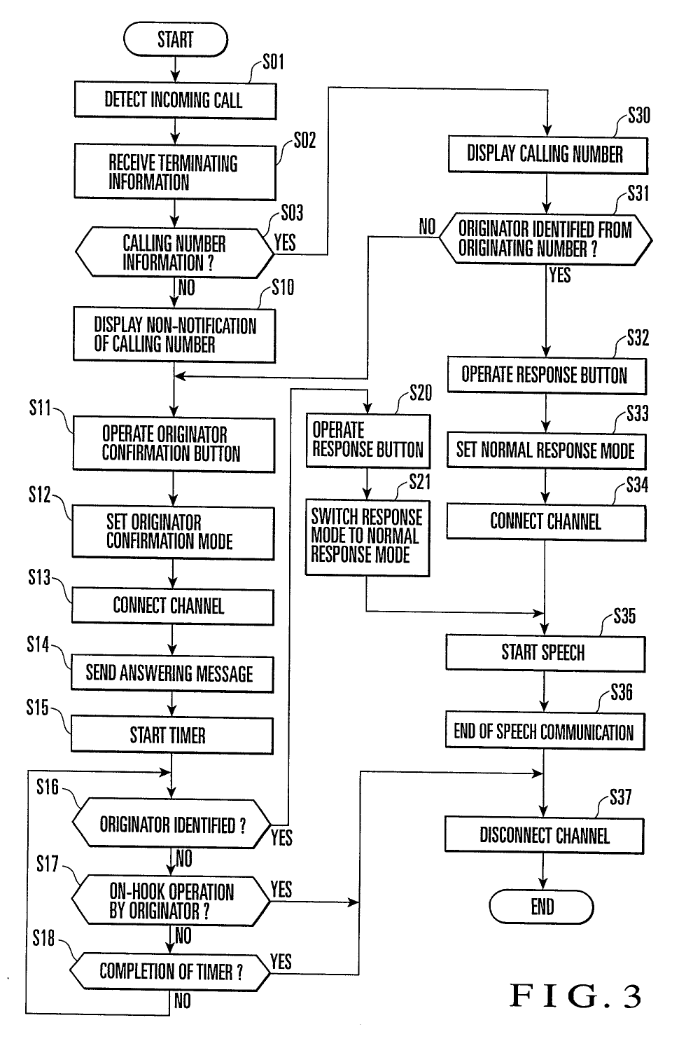

The operation of the portable telephone shown in FIG. 2 will be explained with reference to the flow chart shown in FIG. 3.

The controller 1 detects an incoming call (step S01), and receives terminating information (step S02). The received terminating information is processed by the signal processor 3, and whether the terminating information contains a calling number is checked (step S03). If NO in step S03, the display controller 21 displays on the display 4 a message representing that no calling number was notified (step S10). If YES in step S03, the display controller 21 displays the calling number on the display 4 (step S30).

If the display 4 displays this message, the recipient operates the originator confirmation button 6 of the operation unit 7 in order to identify the originator (step S11). Then, the response mode controller 20a controls the response mode to the originator confirmation mode, and enables the receiver 10 and recording unit 8 (step S12). At the same time, the channel controller 20 connects a channel (step S13), sends an answering message recorded in the recording unit 8 to the channel, and outputs the answering message from the receiver 10 (step S14). After the answering message is output, the response operation controller 2 starts the timer 11, and starts counting the speech duration in the originator confirmation mode (step S15). At this time, if speech from the originator is received, it is monitored and output from the receiver 10.

If the recipient can confirm the originator from the speech output from the receiver 10 (YES in step S16), he/she presses the response button 5 of the operation unit 7 (step S20). Then, the originator confirmation mode is switched to the normal speech mode (step S21). The response operation controller 2 stops the timer 11, and enables the transmitter 9.

If the recipient cannot confirm the originator from the speech output from the receiver 10, the channel is disconnected (step S37) upon the on-hook operation by the originator (step S17) or the completion of the timer 11 (step S18).

If the calling number is displayed on the display 4 in step S30, the recipient determines whether the originator can be identified from the displayed calling number (step S31). If YES in step S31, the recipient presses the response button 5 of the operation unit 7 (step S32). Then, the response mode controller 20a sets the normal speech mode (step S33), and enables the transmitter 9 and receiver 10. The channel controller 20 connects a channel (step S34) to start the speech communication (step S35). If the speech communication ends (step S36), the channel controller 20 disconnects the channel (step S37).

If the partner cannot be identified from the calling number displayed in step S30 (NO in step S31), the recipient operates the originator confirmation button 6 of the operation unit 7 (step S11). The response mode controller 20a sets the originator confirmation mode (step S12), and the channel controller 20 connects a channel (step S13). The subsequent operation is the same as that when the originator confirmation mode is set.

The above-described terminating response operation will be explained by giving attention to the operation of the recipient.

For example, if calling number information 090-1111-1111 is received in terminating operation (steps S02 and S03), it is displayed on the display 4 (step S30). If the recipient can identify the originator from the displayed calling number (YES in step S31), he/she operates the response button 5 (step S32), connects the portable telephone to the channel in the normal response mode, and starts the speech communication (steps S33 to S35).

If NO in step S31, the recipient operates the originator confirmation button 6 (step S11), and connects a channel in the originator confirmation mode (steps S12 to S14). After the channel is connected, an answering message “I'm sorry, but I cannot answer the phone. Please leave your name and your phone number within 30 sec after a beep.” recorded in the recording unit 8 is transmitted to the originator. This transmission message is confirmed by the recipient via the monitor 24 and receiver 10 (step S14).

After the message is transmitted, the timer 11 for counting a speech duration of 30 sec in the originator confirmation mode starts (step S15). During timer operation, a speech signal from the originator is output from the receiver 10. If the recipient can identify the originator from the speech from the receiver 10 (YES in step S16), he/she presses the response button 5 of the operation unit 7 (step S20), and switches the originator confirmation mode to the normal response mode (step S21). If NO in step S16, the originator confirmation mode is maintained, and the channel is disconnected (step S37) upon the on-hook operation by the originator or the completion of the timer 11 which has measured the speech duration in the originator confirmation mode (step S17 or S18).

If no calling number information is received in step S03, “no calling number was notified.” is displayed on the display 4 (step S10). The recipient operates the originator confirmation button 6 of the operation unit 7 (step S11) to enable response in the originator confirmation mode (step S12).

In the first embodiment, the originator confirmation button 6 is used when the originator cannot be confirmed, but can also be used even when the originator can be confirmed. That is, if the operator does not want to answer the phone, he/she presses the originator confirmation button 6 to shift the normal response mode to the originator confirmation mode, thereby making no response to an incoming call without notifying the originator that he/she does not answer the phone intentionally. In addition, the recipient can receive a message from the originator without communicating with the originator.

The second embodiment will describe an example of disconnecting a channel after sending a response rejection message to the channel while outputting speech from the originator via a receiver. According to the second embodiment, the channel can be immediately disconnected after an incoming call is confirmed to be, e.g., a malicious call.

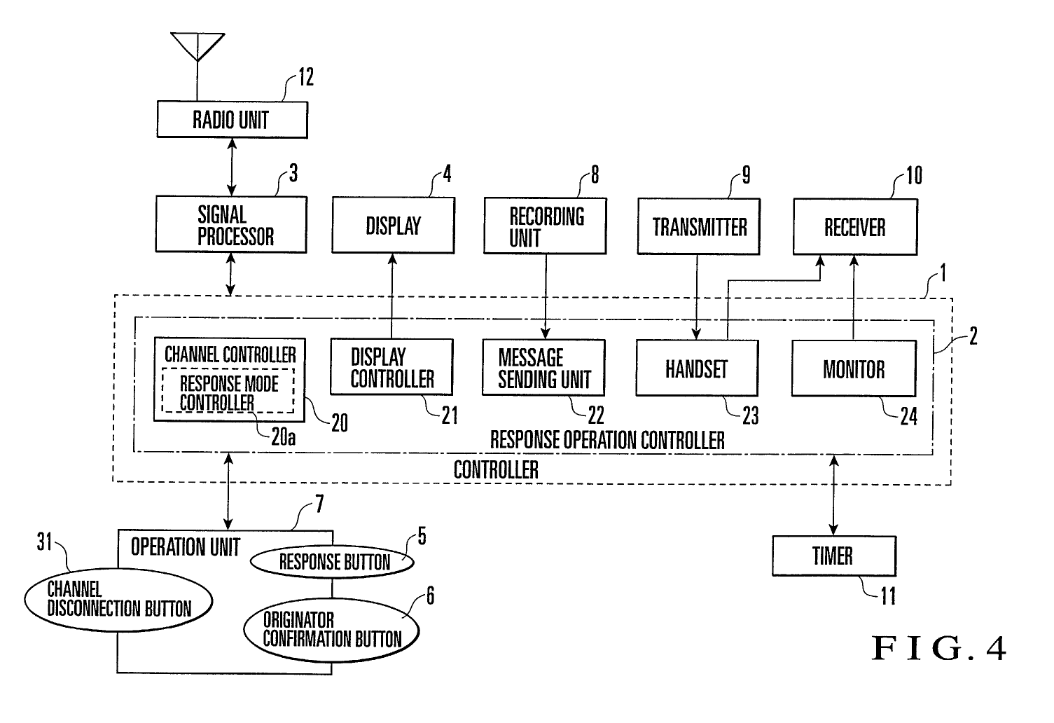

FIG. 4 shows the functional blocks of a portable telephone according to the second embodiment. The portable telephone in FIG. 4 is different from that in FIG. 2 in that an operation unit 7 comprises a channel disconnection button 31 for forcibly disconnecting a channel. The remaining arrangement is as the same as in FIG. 2, and a description thereof will be omitted. With this arrangement, while speech from the originator is output from a receiver 10, the channel disconnection button 31 is operated to disconnect the channel after a response rejection message recorded in a recording unit 8 in advance is sent to the channel via a message sending unit 22.

The third embodiment will describe an example of automatically switching the normal response mode to the originator confirmation mode when no calling number is received.

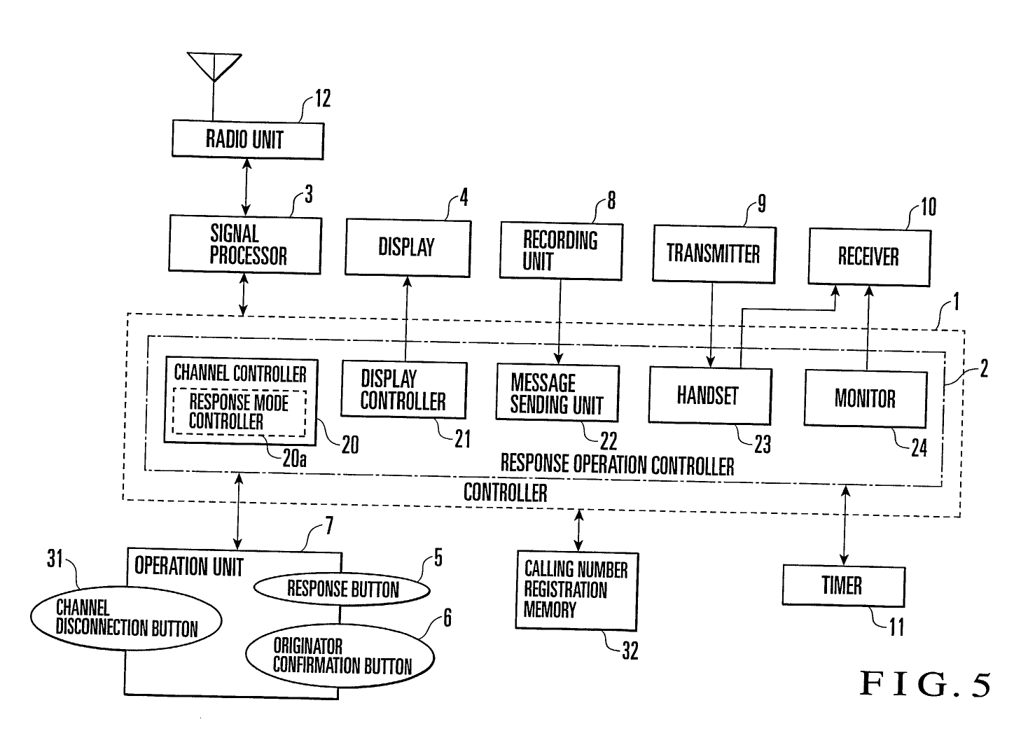

FIG. 5 shows the functional blocks of a portable telephone according to the third embodiment. The portable telephone in FIG. 5 is different from the portable telephone in FIG. 4 in that a calling number registration memory 32 for registering the calling number of the originator is arranged, and the calling number of the originator to which the recipient responds in the normal response mode is registered in the calling number registration memory 32 in advance. In the third embodiment, an originator confirmation button 6 may be omitted.

With this arrangement, not only when no calling number is received, as described above, but also when a calling number received in terminating operation is not registered in the calling number registration memory, the channel is automatically connected (automatic answering) upon the lapse of a predetermined time after terminating operation, and a message prompting the originator to respond is sent to the channel via a message sending unit 22 (originator confirmation mode).

In each embodiment, the timer 11 starts after a message is sent, but may start when the originator confirmation mode is set, the channel is connected, or transmission of a message starts.

As has been described above, according to the present invention, even when the calling number of the originator is not notified, or when the partner cannot be specified from the calling number, the channel can be connected in the originator confirmation mode to identify the originator from speech from the originator. As a result, a response to an annoyance or nuisance call can be avoided when the originator cannot be specified.

Since the originator confirmation mode and normal speech mode can be selected by button operation, a different response method can be selected in accordance with the calling number of the originator upon terminating operation.

Even during the speech communication in the originator confirmation mode, this mode can be switched to the normal speech mode by pressing the response button. Immediately after the partner is confirmed, the originator confirmation mode can be switched to the normal speech mode.

In addition, a message from the originator can be received without communicating with the originator.

What is claimed is:

1. A portable telephone with an originator acknowledge function, comprising:
an originator confirmation button and response button;
response mode control means for controlling a response mode to an originator confirmation mode in which only reception is possible when said originator confirmation button is operated, and controlling the response mode to a normal response mode in which both transmission and reception are possible when said response button is operated;
display means for displaying a calling number received in terminating operation;
channel control means for activating said response mode control means and connecting a channel in the originator confirmation mode in accordance with an operation of said originator confirmation button in terminating operation;
message sending means for sending a first message prompting a response of an originator to the channel when the channel is connected in the originator confirmation mode; and
monitor means for outputting a speech signal of the originator from the channel to a recipient via a receiver after the first message is sent,
wherein said response mode control means switches the response mode from the originator confirmation mode to the normal response mode when said response button is operated during the originator confirmation mode.

2. A portable telephone according to claim 1, wherein
said portable telephone further comprises timer means for measuring a predetermined time after the first message is sent, and
said channel control means disconnects the channel when said timer means measures the predetermined time.

3. A portable telephone according to claim 1, wherein
said portable telephone further comprises timer means for measuring a predetermined time after the originator confirmation mode starts, and
said channel control means disconnects the channel when said timer means measures the predetermined time.

4. A portable telephone according to claim 1, wherein
said portable telephone further comprises a channel disconnection button, and
the channel is forcibly disconnected immediately after said message sending means sends a second message representing rejection of a response when said channel disconnection button is operated during the originator confirmation mode.

5. A portable telephone according to claim 1, wherein
said portable telephone further comprises a calling number registration memory for registering a calling number in advance,
said channel control means connects the channel in the originator confirmation mode a predetermined time after terminating operation when a calling number received in terminating operation is not registered in said calling number registration memory, and
said message sending means sends the first message to the channel after the channel is connected.

6. A portable telephone according to claim 1, wherein
said portable telephone further comprises a transmitter and receiver for transmitting and receiving speech to and from the originator via the channel, and
said response mode control means enables only said receiver in the originator confirmation mode, and enables both said transmitter and receiver in the normal response mode.

7. A portable telephone according to claim 6, wherein said monitor means outputs the first message sent to the channel from said receiver to the recipient.

8. A portable telephone with an originator acknowledge function, comprising:
an originator confirmation button for confirming an originator;
a response button for setting a normal speech communication state;
display means for displaying a calling number received in terminating operation;
channel connection means for connecting a channel in accordance with an operation of said originator confirmation button and response button in terminating operation;
message sending means for sending to the channel a message prompting a response to the originator in accordance with an operation of said originator confirmation button in terminating operation;
monitor means for sending a speech signal received via the channel to a receiver for a predetermined time and performing monitor operation after the message is sent; and
transmission/reception means for setting a speech communication state in accordance with an operation of said response button during monitor operation.
